(19) United States
(12) Patent Application Publication
(10) Pub. No.: US 2008/0002145 A1
(43) Pub. Date: Jan. 3, 2008

(54) Adaptor For Signal Communicative Members For Eyewear

(76) Inventor: Richard Kazuhiro Sanpei, Paso Robles, CA (US)

Correspondence Address: BAKER, DONELSON, BEARMAN, CALDWELL & BERKOWITZ, SIX CONCOURSE PARKWAY, SUITE 3100, ATLANTA, GA, 30328, US

(21) Appl. No.: 11/833,212

(22) Filed: Aug. 2, 2007

Related U.S. Application Data
(63) Continuation-in-part of application No. 11/288,917, filed on Nov. 29, 2005.

(51) Int. Cl. G02C 11/00; H04R 1/10

(52) U.S. Cl. 351/158; 381/381

(57) ABSTRACT

An audio earplug adaptor configured to be received on a leg of an eyewear device for a human being in which a body having a support member configured to engage an earplug having a speaker assembly, which earplug communicates with an audio signaling device; and the body selectively attached to a leg of an eyewear device, whereby an earplug positioned in the support member is selectively oriented relative to an ear of a human being for communicating sound from the audio signaling device, the adaptor one of a plurality of adaptors selected for use depending on the configuration of the earplug to be used.

This application is a continuation in part of co-pending application Ser. No. 11/288,917 filed Nov. 29, 2005.

### TECHNICAL FIELD

The present invention relates to eyewear devices. More particularly, the present invention relates to eyewear devices adapted for holding a selected signal communicative member useful with eyewear and with portable audio devices.

### BACKGROUND OF THE INVENTION

Eyewear devices have long been provided for a number of different purposes including the correcting of the vision of persons, the shielding eyes from glare, and the protecting of eyes from injury from flying debris such as from manufacturing, machine work, forestry, construction, and other work activities. Eyewear devices typically have a front panel defined by a frame and a pair of lenses mounted in the frame in alignment with the eyes of the person wearing the eyewear device. The frame includes a bridge that rests directly or on extended pads on the upper ridge of the nose. Temples extend from sides of the frame rearwardly along opposing sides of the face and terminate in rounded end portions that seat arcuately over and behind the ears. Often the eyewear is connected to a neck cord for supporting the eyewear when not in use by the person, typically reading glasses or sunglasses but other eyewear that is not required continuously for use.

In addition to protecting eyes, devices have been provided for aural protection of a person. Generally, these types of devices insert into the ear and close or reduce communication of sound waves to the inner ear. These devices are typically compressed from a nominal size to a reduced size for being received within the ear. Upon release, the device seeks to resume its normal size by expansion. The sides of the device press again the ear surfaces and close the ear to significant communication of sound waves.

While protection of eyes and vision and of ears and hearing is important, recent developments in technology provides a number of portable audio devices including radios for receiving broadcasts and recording and playback devices that have storage capacity for many hundreds of minutes of audio signals. The recording and playback devices enable a person to have selected music, oral recitations of published books, or similar oral audio content. The audio devices typically can be attached with holders to the clothing of the person using the devices.

In addition, communication between persons is facilitated using wireless communication devices including cellular telephones, BLUETOOTH communication devices or the like, as well as wired telephonic devices.

The devices include plug-in speakers or headsets whereby the person using the device may set an audio volume level for comfortable listening but the audio level is insufficient for nearby persons to hear. The speakers typically have housing known in the trade as “ear buds” configured for disposing within an ear while headsets position speakers outwardly of the ear. The speakers and headsets connect through signal carrying wires that connect with a plug to a signal output receptacle on the audio device. The wires overlie the clothing and extend from the device to the headset or ear buds. The wires however may interfere with the use of the eyewear. The wireless devices provide a speaker, or in the instance of telecommunications, a transceiver for receiving and transmitting audio signals.

The ear buds for audio equipment generally are available in two styles. A first style includes a cylindrical stem with a semi-spherical or rounded housing that contains a speaker. A signal cord connects to the speaker and passes through the stem to a distal end having a plug for electrically communicating with a mating jack of the audio device. The second style provides a semi-spherical or rounded housing that contains a speaker, and the signal cord connects directly to the speaker in the housing. Generally the second style is a SONY type earplug while the first style is an IPOD earplug.

Accordingly there is a need in the art for a connector that receives a selectively connectable signal communicative member for use with eyewear and audio devices. It is to such that the present invention is directed.

### SUMMARY OF THE INVENTION

The present invention meets the need in the art by providing an audio earplug adaptor configured to be received on a leg of an eyewear device for a human being, comprising a body having a support member configured to engage an earplug having a speaker assembly, which earplug communicates with an audio signaling device; and means for attaching the body to a leg of an eyewear device, whereby an earplug positioned in the support member is selectively oriented relative to an ear of a human being for communicating sound from the audio signaling device.

In another aspect, the present invention provides an eyewear device for use by a human being, comprising a front guard member including a lens portion for protecting the eyesight of the human being and having opposing ends; a bridge portion located medial the opposing ends of the front guard member to support the lens portion from the nose of the human being, and a pair of temples hingably attached at one end to respective distal portions of the bridge portion. At least one hearing assembly includes a leg pivotally attached to one of the temples allowing for rotational movement of the leg relative to the temple; and a body attached to the leg and configured to engage an earplug having a speaker assembly, which earplug communicates with an audio signaling device, whereby an earplug positioned in the body is selectively oriented relative to an ear of a human being for communicating sound from the audio signaling device.

Objects, advantages and features of the present invention will become apparent from reading of the following detailed description of the invention and claims in view of the appended drawings.

### BRIEF DESCRIPTION OF THE DRAWINGS

FIG. 1 illustrates in top plan view an eyewear device and sound earpods for connecting to a sound source, according to the present invention.

FIG. 2 illustrates in perspective view a neck cord for supporting eyewear not in eyewear use while providing audio signals through earpod speakers, in accordance with the present invention.

FIG. 3 illustrates in detailed exploded view an alternate embodiment of the eyewear and neck cord apparatus illustrated in FIG. 1.

FIG. 4 illustrates in side view an eyewear device illustrated in FIG. 1 with an alternate embodiment sound earpod that incorporates a microphone, for connecting to a bi-directional communication device.

FIG. 5 illustrates in exploded detailed view an adaptor of a first embodiment for engaging selectively an earpod speaker for use with an audio device and eyewear.

FIG. 6 illustrates in perspective side view a second embodiment of an adaptor for engaging selectively an earpod speaker for use with an audio device and eyewear.

FIG. 7 illustrates in exploded perspective view a second connector for attaching the adaptor to an eyewear device.

FIG. 8 illustrates in exploded perspective view a third connector for attaching the adaptor to an eyewear device.

FIG. 9 illustrates in perspective view a body for receiving an earpod speaker and for attaching to the leg for the eyewear device.

FIG. 10 illustrates in perspective view the body illustrated in FIG. 9 attached to the leg for the eyewear device.

FIG. 11 illustrates in perspective view a pad for attaching to the leg for the eyewear device.

FIG. 12 illustrates in perspective view a body having an extending pin for receiving an earpod device.

### DETAILED DESCRIPTION

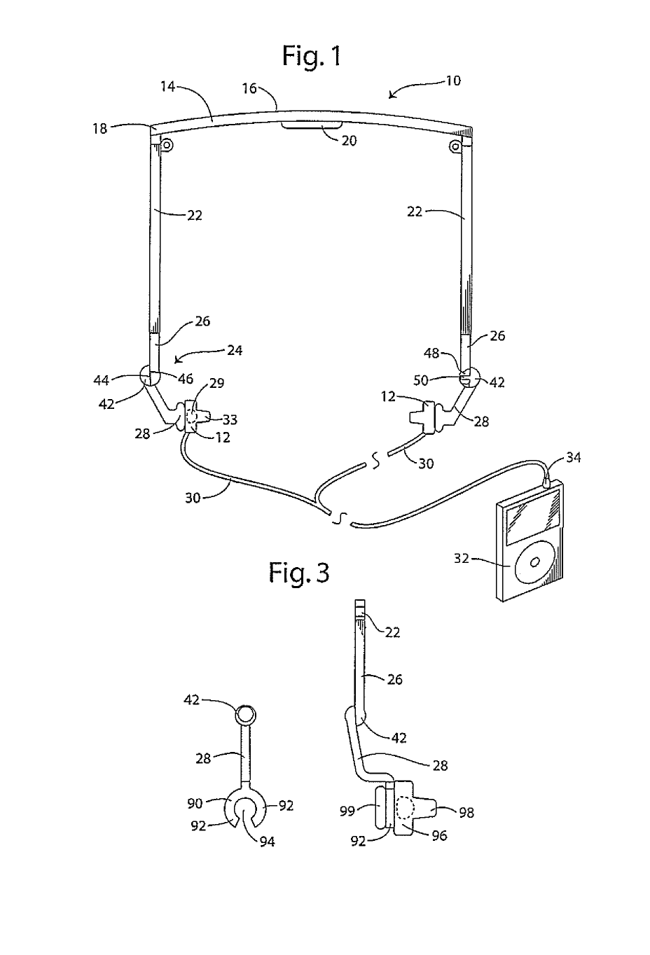

Referring now in more detail to the drawings in which like numerals refer to like parts throughout the several views, FIG. 1 illustrates in top plan view an eyewear device 10 with a sound communicating earpod 12 according to the present invention useful for communicating sound through sound communicators or speakers within the earpod in conjunction with ordinary use of the eyewear device 10.

My U.S. Pat. No. 6,382,213 describes an eyewear device for the protection of sight and hearing that readily configures for the present invention. The eyewear 10 includes a front guard portion 14 having a transparent panel section 16 connected to an elongated resilient member 18. A bridge member 20 extends from the member 18 for seating on a ridge of a nose of the wearer of the eyewear. Temples 22 hingedly attach to respective ends of the member 18 and pivot between an overlapping closed position against the panel section 16 and a substantially perpendicular extended position for wearing use.

A hearing assembly generally 24 attaches to at least one of the temples 22. Each hearing assembly 24 includes an arm 26 configured to connect with the end of the temple 22, such as a mating tubular member or a telescoping member, and a leg 28 pivotally attached to the arm 26 allowing for rotational movement of the arm and leg around the pivoting attachment. It is to be appreciated that the arm 26 may connect to the distal end of the temple 22 in other conventional ways, such as integrally or fixedly attached. An audio earpod 12 includes a speaker 29 for communication of sound and attaches to a distal end of the leg 28. The speaker in the earpod 12 connects by wires 30 to a sound source 32. The sound source 32 is any number of types of sound communicative devices, such as a personal music recording and playback device, cellular telephone, or receiver player device configured for receiving remote radio broadcast signals from antennas, communications towers, satellite, or other signal communication apparatus, including wired (local sound device to speaker) or wireless telecommunications devices.

The earpod 12 includes a housing that holds the speaker 29 and a distal portion is formed of a cushion or resilient material such as foam or soft plyable plastic configured for being received within an ear of the person using the eyewear 10. The wires 30 attach to the speaker in the earpod 12 and terminate at a connector 34 for connection to the source 32 of sound.

The arm 26 and leg 28 are connected by a hinge or pivot 42 so as to allow rotational movement around the pivot. The arm 26 and leg 28 each have opposing planar surfaces 44, 46 that contact and connect with a pivot post 48 extending from the planar surface 44 as shown in cut-away view on the right side in FIG. 1 through a pivot hole 50. The surfaces 44, 46 in the illustrated embodiment are knurled or roughened with projections so as to provide resistance to movement of the arm and leg in their relationship to each other. In an alternate embodiment, a washer is disposed between the planar surfaces 44, 46 to guide the relative movement of the arm and leg. Other hinge connection or hinging structure may be gainfully employed for providing the leg with selective angled orientation, to accommodate positioning the earpod or speaker relative to an ear of a user.

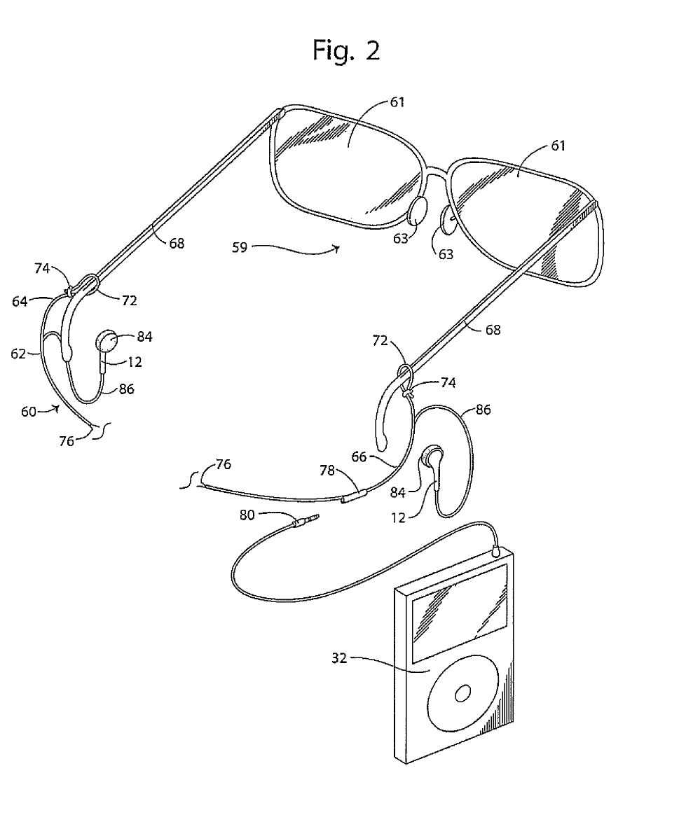

FIG. 2 illustrates in perspective view a conventional eyewear device 59 having lens 61 and bridge feet 63, with a neck cord 60 for supporting the eyewear while not in eyewear use and providing audio signals through earpod speakers 12, in accordance with the present invention. The neck cord 60 comprises an elongated band 62 having opposing distal ends 64, 66 configured for attaching to temples 68 of the eyewear device 59. In the illustrated embodiment, the distal ends 64, 66 of the neck cord 60 each include a looped portion 72 formed by a clip 74 that holds looped distal portions of the band 60. The elongated band 60 includes a signal carrier or wires 76 for carrying a stereo audio signal to the opposing pair of earpods 12. The wires 76 attach to a connector or jack 78 attached to the band 60. The connector 78 selectively detachably engages a mating connector 80 that operatively communicates with the signal source 32. As discussed above, the signal source 32 is a source of sound, such as a personal music recording and playback device, cellular telephone, or receiver player device configured for receiving remote radio broadcast signals from antennas or satellite. The band 60 is made of a protective material, such as a fabric material such as cotton, polyester, or other fabric, or rubber, plastic, or other flexible moldable material, and encloses within the band the wires 76.

The signal carrier 76 connects to a pair of sound communicators or speakers in the earpods 12. The earpods 12 in the illustrated embodiment each include a bulbular housing 84 that encloses a speaker. The housing 84 is configured for being received and held within an ear of the person using the eyewear device 10. The sound communicators attach at respective ends with a free length generally 86 at an end portion of the neck cord 60, to facilitate positioning the sound communicators within the respective ears spaced from the temples 68 of the eyewear device 59. It may be appreciated that the neck cord 60 is readily used with the eyewear device 10 illustrated in FIG. 1.

In an alternate embodiment illustrated in FIG. 3, the leg 28 of the audio assembly 24 terminates at a distal end with a receiving port 94. The receiving port 94 detachably receives an audio earpod 96 containing (as does the earpod 12) a speaker and a cushioned end 98 for being received within an ear. In the illustrated embodiment, the receiving port 94 is defined by arcuate opposing members 92 that cooperatively define a C-shaped structure. Other shapes can be gainfully employed for receiving and holding the earpod 96. The audio earpod 96 is configured at one end 99 for mating engagement with the receiving port 94. The earpod 96 selectively detaches from the receiving port 94 and the speaker therein is removed, for replacement of the cushioned portion of the earpod, to enable replacement after extensive use.

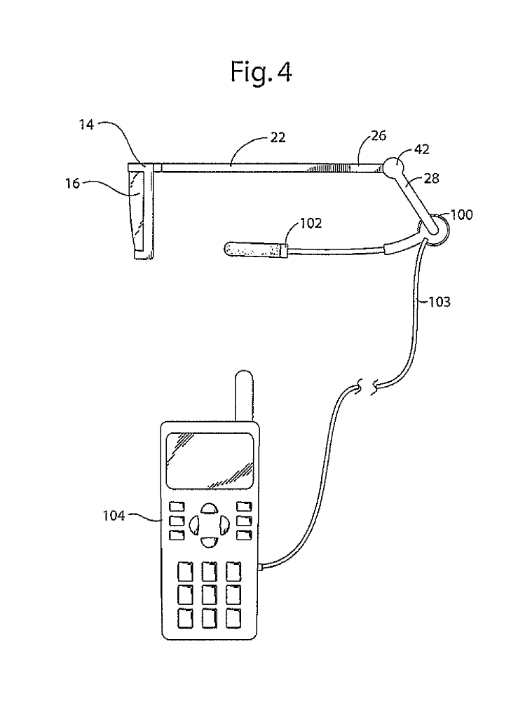

FIG. 4 illustrates in side view the eyewear device 10 illustrated in FIG. 1 with an alternate embodiment sound earpod 100 in the hearing assembly 24 attached to one of the temples 22. The earpod 100 incorporates the speaker 29 together with a microphone 102 and cord 103 for connecting to a bi-directional communication device 104 such as a cellular telephone, radio receiver, transceiver device, or telecommunication device including BLUETOOTH devices and similar wireless communications developments. The other temple 22 may include the hearing assembly 24 having the earpod 12, as discussed above, either wireless or wired.

With reference to FIG. 1, the arms 26 extend selectively from the temples 22 and the legs 28 pivot relative to the arms 26, to position the earpods 12 aligned with the ears for being fitted within or aligned with the ears of a user. The sound source 32 connects with the connector 34 to the wires 30 for communicating audio signals through the wires to the speakers in the earpods 12. As noted above, the sound source may readily be a wireless device or communicate wirelessly with the earpods 12 such as for example a BLUETOOTH transceiver device. It is to be appreciated that the speaker can be enclosed by a large foam pad, so that the speaker is positioned outwardly of but aligned with and seating on the exterior ear for communicating sound.

With reference to FIG. 2, the neck cord 60 attaches with the looped distal portions 72 sliding over the distal ends of the temples 68. The neck cord 60 allows suspending the eyewear 59 (or 10) about the neck of the person using the eyewear, for example, sunglasses and the person removes the sunglassess when inside a building or in shade, with the eyewear suspended about the neck. However, the neck cord 60 facilitates use of the person's audio device or signal source 32 by connecting the connectors 28 and 30. The signal from the signal source 32 communicates through the wires 76 to the speakers in the earpods. The housings 84 are received in the ears of the wearer for communicating the sound to the person.

With reference to FIG. 3, the earpod selectively detachably engages the hook 90 of arm 28. After use or wear of the housing, the earpod can detach from the hook, and the cushioned pad removed and replaced. After replacement with a new cushion receiving the speaker, the earpod re-attaches to end of the leg, such as by engaging the hook 90 or other connection structure on the leg, such as a threaded screw extending through an opening in the leg into the earpod.

The eyewear 10 illustrated in FIG. 4 is particularly configured with an alternate embodiment hearing assembly 24 for bi-directional communication using a cellular telephone 104 or similar device for listening to audio through the sound earpod 100 and communicating voice or sound though the microphone 102. The opposing temple may include the earpod 12, or lack the earpod, so only one ear of the person using the eyewear device is provided with sound from the sound source. That opposing earpod may be of a type to dampen sound to the ear. It is noted that the wired connective aspect using signal carrying member 103 can be replaced with a wireless transceiver device associated with the earpod 100 and the microphone 102.

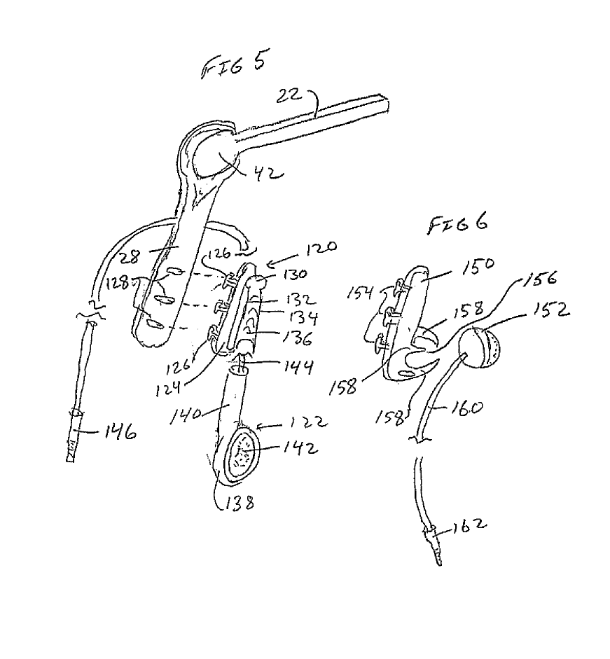

FIG. 5 illustrates in exploded detail view a first embodiment of an adaptor 120 that engages selectively an earpod speaker 122. The adaptor 120 includes a body 124 that attaches to the pivotal leg 28 of the eyewear. The adaptor 120 connects with fasteners to the leg 28. In the illustrated embodiment, the body 124 includes a plurality of projecting lugs 126. The leg 28 defines openings 128. The lugs 26 extend through the openings 128 to selectively attach the body 124 to the pivotal leg 28. Other attaching mechanisms may be used. For example, another embodiment uses one lug or two spaced-apart lugs that are received in respective openings. Further, the adaptor 120 may be fastened with screws or other connector or be adhered in place.

The body 124 further includes a support member 130 configured to receive and hold a communications member such as the earpod speaker 122. In the illustrated embodiment the support member 130 is an elongated member configured to engage the earpod speaker 122. In this embodiment, the support member 130 includes a semi-cylindrical portion that defines a C-shape channel in transverse cross-section. Opposing edges 132, 134 define a gap 136. The earpod speaker 122 includes a rounded or semi-spherical housing 138 from which a cylindrical member or stem 140 extends. The channel of the support member 130 receives the stem 140 to attach the earpod speaker 122 to the eyewear for selective aligning the speaker relative to the ear. The housing 138 includes a speaker 142. A signal cord 144 extends from the stem 140 and includes a jack 146 at a distal end for connecting to a audio or video device (not illustrated). In an alternate embodiment, the earpod can be configured for wireless communication with a sound source.

FIG. 6 illustrates in perspective view a second embodiment of an adaptor 150 configured for receiving and holding a rounded housing for an earpod speaker 152. The adaptor 150 includes lugs 154 for extending through the openings 128 in the leg 28 illustrated in FIG. 5. The adaptor 150 defines a cup-shaped receiver 156. The receiver in the illustrated embodiment is defined by three spaced-apart arcuate fingers that curve from a outer extent of the receiver 156 inwardly. The fingers 156 are flexible, so that the speaker housing 152 can readily be received past the fingers into the cup-shape receiver 156. It is appreciated that the configuration and shape of the receiver depends on the structural configuration of the particular earpod speaker to be attached, for example two fingers or a cup-shaped dished portion defining the receiver. A gap in the body of the adaptor 150 permits the signal cord 160 to extend outwardly of the receiver 156 and connect with a jack 162 to a audio or visual device for communication of sound signals to the speaker 152.

The adaptors are structured for detachably engaging the leg 28, and can include earpod devices both wired and wireless and fixed to the adaptor as a unit or selectively attachable. Thus, a user may have a first adaptor for use with a personal music device and conventional earpod speakers connected by a wire, a second adaptor that includes a fixed transceiver for communicating wirelessly with a cellular telephone, and yet a third adaptor configured for engaging another style of earpod speaker.

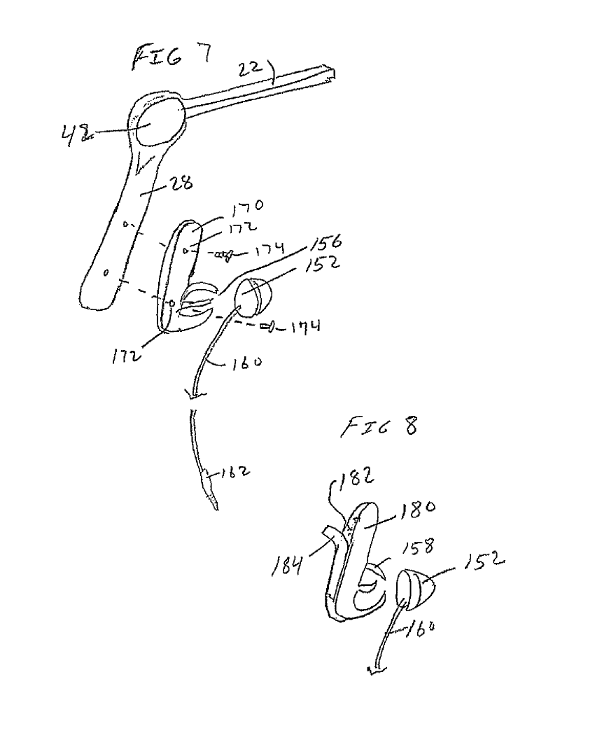

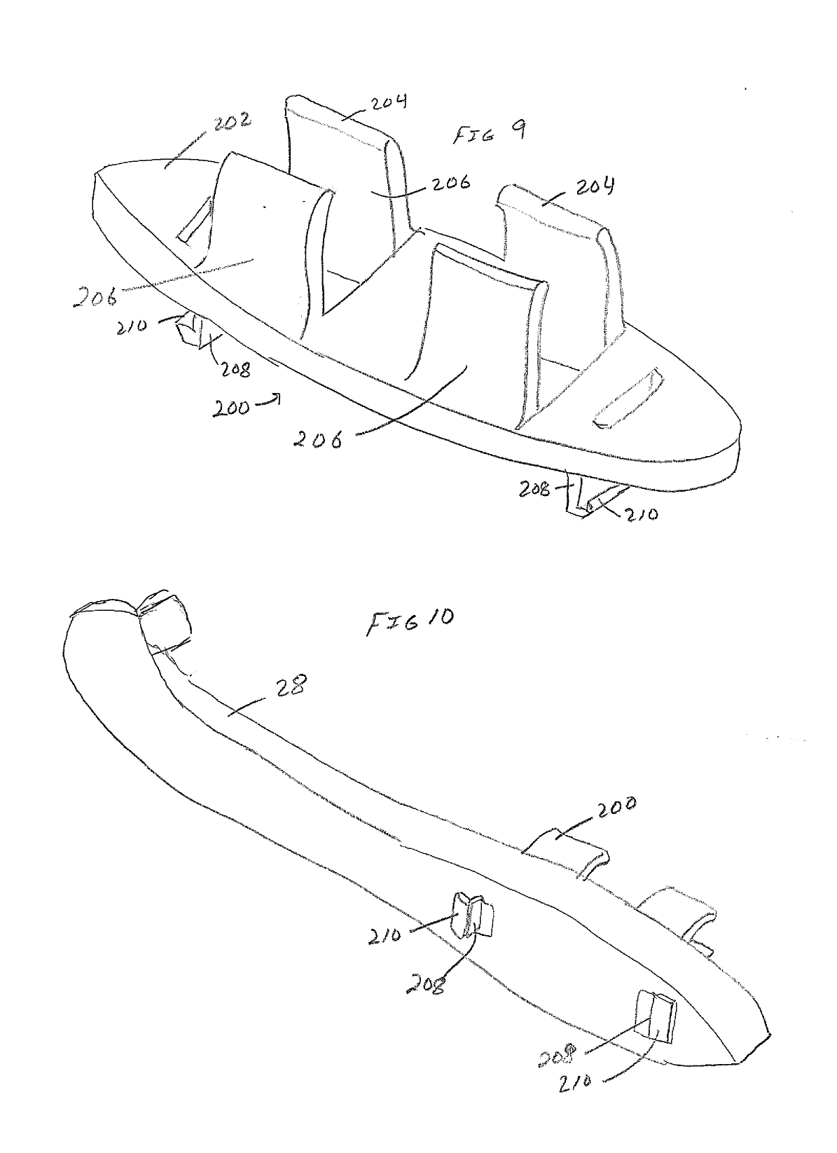

It is to be appreciated that adaptors 120, 150 for earpods readily attach with other connectors to the leg 28. FIG. 7 illustrates in exploded perspective view an adaptor 170 that defines a plurality of openings 172. Fasteners 174 such as screws extend through the adaptor 170 and into the leg 28 secure the adaptor to the eyewear device. FIG. 8 illustrates in exploded perspective view an adaptor 180 having an adhesive layer 182 covered by a selectively removed sheet 184 for attaching the adaptor to an eyewear device. Further, other support members configured for particular earpod sound devices may readily be employed in accordance with the present invention.

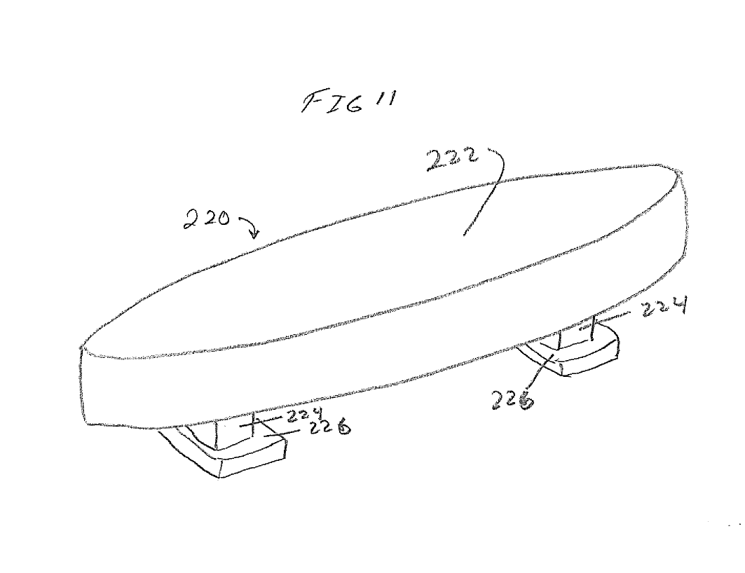

FIG. 9 illustrates in perspective view a body 200 of an alternate configuration for selectively engaging an earpod speaker (not illustrated). The body 200 includes a base 202 from which opposing walls 204, 206 extend and define a channel 206 for receiving a stem of an earpod. A pair of tabs 208 project from the base 202 and include laterally extending flanges 210. As illustrated in FIG. 10, the body 200 connects to the leg 28 by the tabs 208 extending through openings 212 defined in the body. The flanges 210 overlap portions of the surface of the leg 28. The body 200 is readily detached by moving the tabs 208 towards each other to release the flanges 210 from engaging the surface of the leg and pulling the body laterally away from the leg. In accordance with the present invention, a selected alternate configured body can then be attached for use of another type of sound communicative device. The body 200 is readily molded of a plastic material.

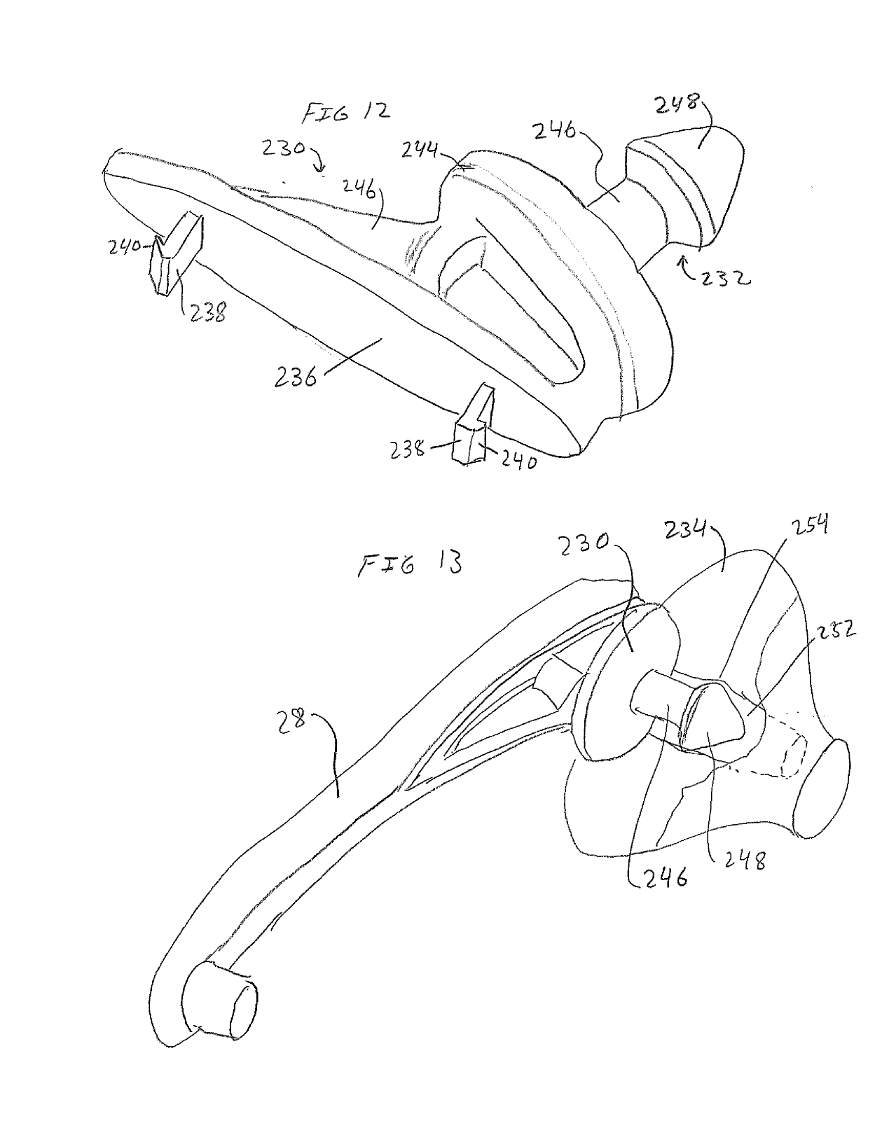

FIG. 11 illustrates in perspective view a pad 220 for attaching to the leg 28 for the eyewear device. The pad 220 cushions against the ear when selectively used, and selectively configured may dampen sound. The pad 220 includes a base 222 from which tabs 224 extend. In this embodiment, the tabs 224 terminate in feet having laterally extending opposing flanges 226 . The tabs 224 extend through openings defined in the leg 28 to configure to the tabs 224. The flanges 226 of the feet bear upon the surface of the leg to secure the pad 220 to the leg. The pad 220 is removed by pulling the pad laterally from the leg and with pressure to the flanges moving the feet through the openings, for selective replacement with a selected another adaptor. The pad 220 is readily manufactured of plastic, foam material or other sound dampening or cushioning material.

FIG. 12 illustrates in perspective view a body 230 configured with a projecting pin 232 for selectively receiving an earbud 234 (illustrated in perspective cut-away view in FIG. 13). The body 230 includes a base 236 from which opposing tabs 238 project. The tabs 238 in the illustrated embodiment include outwardly angled flanges 240. The tabs 238 are exemplary and not limiting of connecting members that selectively attach the adaptor to the leg of the eyewear device. The body 230 includes a support portion generally 242 and a table 244 from which the pin 232 extends. The pin 232 includes a shaft 246 and a distal end of the shaft terminates in a nipple 248. The nipple 248 in the illustrated embodiment tapers to an apex, and at a base has a diameter greater than that of the shaft 246. As illustrated in FIG. 13, a bulbular earpiece 234 made of a resilient material such as rubber, foam rubber, or the like sound-dampening material, defines a central bore 252 open on at least one end. The pin 232 extends into the bore 252, and the nipple 248 engaging contacts an interior wall (see 254) that defines the bore. The nipple 248 secures the bulbular earpiece 250 to the body 230. The body 230 with the attached earpiece 250 connects to the leg 28.

The present invention accordingly provides adaptors selectively attached to an eyerwear device for sound communication or dampening purposes. The particular connecting elements such as the tabs and lugs are but examples and not limiting, so that the adaptors can be readily configured for particular sound devices, and the user can selectively attach a particular one and electively remove it for using another such one of the plurality of adaptors. Further, as discussed herein, the speaker devices can readily be wired or wireless for use of the adaptors with a variety of sound devices such as personal music or video devices, cellular telephones, and the like, or even without sound devices such as sound dampening earplugs.

This specification has described the present invention that provides an adaptor selectively attached to an eyewear device which adaptor is configured for receiving an earpod for communicating sound to the ear of a person wearing the eyewear, which adaptor is one of a plurality that can be selected depending on the earpod to be used. It is to be understood, however, that numerous changes and variations may be made in the construction of the present hard cover product within the spirit and scope of the present invention, and that modifications and changes may be made therein without departing from the scope thereof as set forth in the appended claims.

What is claimed is:

1. An audio earplug adaptor configured to be received on a leg of an eyewear device for a human being, comprising:
a body having a support member configured to engage a communications device having a speaker assembly, which earplug communicates with an audio signaling device; and
means for attaching the body to a leg of an eyewear device,
whereby the communication device positioned in the support member is selectively oriented relative to an ear of a human being for communicating sound from the audio signaling device.

2. The audio earplug adaptor as recited in claim 1, wherein the communications device is an earpod speaker.

3. The audio earplug adaptor as recited in claim 1, wherein the support member comprises an elongated member that is C-shaped in traverse direction and defines a gap between opposing edges; and the earplug includes a speaker housing and an elongated stem from which a signal communicative cord extends, the elongated stem received in the elongated member.

4. The audio earplug adaptor as recited in claim 1, wherein the support member comprises a cup-defining member configured to receive a housing of the earplug.

5. The audio earplug adaptor as recited in claim 4, wherein the cup-defining member comprises arcuate inwardly directed spaced-apart fingers, the fingers flexibly movable for receiving the housing therein.

6. The audio earplug adaptor as recited in claim 1, wherein the means for attaching comprises a connector for attaching the body to the leg.

7. The audio earplug adaptor as recited in claim 1, wherein the means for attaching comprises at least one lug extending from the body; and wherein the leg defines at least one openings that receives the lug, whereby the body is held to the leg for use of the earplug speaker.

8. The audio earplug adaptor as recited in claim 1, wherein the means for attaching comprises threaded fasteners extending through the body and into the leg.

9. The audio earplug adaptor as recited in claim 1, wherein the means for attaching comprises an adhesive surface for selectively attaching the body to the leg.

10. The audio earplug adaptor as recited in claim 1, wherein the body is selected from a plurality of bodies each configured for receiving a particular earpod.

11. An eyewear device for use by a human being, comprising:
a front guard member including a lens portion for protecting the eyesight of the human being and having opposing ends;
a bridge portion located medial the opposing ends of the front guard member to support the lens portion from the nose of the human being;
a hinge connection means attached to each of the opposing ends of the front guard member,
a pair of temples hingably attached at one end to distal ends of the bridge portion,
at least one hearing assembly that includes a leg pivotally attached to one of the temples allowing for rotational movement of the leg relative to the temple; and
a body attached to the leg and configured to engage an earplug having a speaker assembly, which earplug communicates with an audio signaling device,
whereby an earplug positioned in the body is selectively oriented relative to an ear of a human being for communicating sound from the audio signaling device.

12. The eyewear device as recited in claim 11, wherein the body further comprises a support member configured for detachably engaging the earplug.

13. The eyewear device as recited in claim 11, wherein the support member comprises an elongated member that is C-shaped in traverse direction and defines a gap between opposing edges; and the earplug includes a speaker housing and an elongated stem from which a signal communicative cord extends, the elongated stem received in the elongated member.

14. The eyewear device as recited in claim 11, wherein the support member comprises a cup-defining member configured to receive a housing of the earplug.

15. The eyewear device as recited in claim 114, wherein the cup-defining member comprises arcuate inwardly directed spaced-apart fingers, the fingers flexibly movable for receiving the housing therein.

16. The eyewear device as recited in claim 11, further comprising a connector that attaches the body to the leg.

17. The eyewear device as recited in claim 16, wherein the connector comprises at least one lug extending from the body; and wherein the leg defines at least one opening that receives the lug, whereby the body is held to the leg for use of the earpod speaker.

18. The eyewear device as recited in claim 16, wherein connector comprises threaded fasteners extending through the body and into the leg.

19. The eyewear device as recited in claim 11, wherein the connector comprises an adhesive surface for selectively attaching the body to the leg.

20. The eyewear device as recited in claim 11, further comprising:
an elongate band including a signal carrier;
means for attaching the band at opposing distal ends to respective temples of an eyewear device;
a connector attached to the signal carrier for communicating a signal from a signal source selectively coupled to the connector;
the audio earplugs attached to the signal carrier at a respective distal end portion of the band and attached to the body for positioning in alignment with respective ears of a person wearing the eyewear device and when connected to the signal source communicating sound therefrom,
whereby the speakers disposed near the ears for communicating sound from the signal source while the band enables suspending the eyewear when not used for eyewear purposes.

21. An eyewear and audio device for a person, comprising:
a front guard that includes a transparent panel section for disposing forwardly of a pair of eyes for a person, a bridge portion that seats on an upper edge of a nose of the person to support the panel section, and opposing distal ends;
a pair of temples each attached at one end to a respective distal end of the front guard and at least one temple including an earplug sound assembly connected to the opposing distal end;
the earplug sound assembly comprising a leg that pivotally extends from the temple at an oblique angle and includes a support member that engages a sound communicator, the leg selectively oriented relative to the temple for disposing the housing near an ear of a person using the eyewear device;
means for connecting the earplug sound assembly to a signal source for communicating a signal to the sound communicator for communicating sound therefrom,
whereby the sound communicator disposed near the ear for communicating sound from the signal source while the eyewear is being used for eyewear purposes.

22. The eyewear and audio device as recited in claim 21. wherein the support member is one of a plurality of support members each configured for engaging a particular sound communicator and selected for use by the user.

23. The eyewear and audio device as recited in claim 21. wherein the support member comprises an elongated member that is C-shaped in traverse direction and defines a gap between opposing edges; and the sound communicator includes a speaker housing and an elongated stem from which a signal communicative cord extends, the elongated stem received in the elongated member.

24. The eyewear and audio device as recited in claim 21, wherein the support member comprises a cup-defining member having three arcuate inwardly directed spaced-apart fingers configured to flexibly move to receive the sound communicator.

25. The eyewear and audio device as recited in claim 21, further comprising a connector that selectively detachably connects the support member to the leg.

26. The eyewear and audio device as recited in claim 25, wherein the connector comprises a plurality of lugs extending from the support member; and wherein the leg defines a plurality of openings that receive the lugs, whereby the support member is held to the leg for use of the earplug speaker.

27. The eyewear and audio device as recited in claim 25, wherein connector comprises threaded fasteners extending through the body and into the leg.

28. The eyewear and audio device as recited in claim 25, wherein the connector comprises an adhesive surface for selectively attaching the body to the leg.
